(19) United States
(12) Patent Application Publication
(10) Pub. No.: US 2026/0318754 A1
(43) Pub. Date: Oct. 15, 2026

(54) NOISE REDUCTION IN TOTAL AIR TEMPERATURE SENSORS

(71) Applicant: Rosemount Aerospace Inc., Burnsville, MN (US)

(72) Inventors: Elbert Jeyapaul, Bangalore (IN); Sathish Thangavel, Bangalore (IN); Robert Sable, Lakeville, MN (US); Chester Schwie, Burnsville, MN (US)

(21) Appl. No.: 19/395,736

(22) Filed: Nov. 20, 2025

(30) Foreign Application Priority Data
Apr. 11, 2025 (IN) 202541035629

(51) Int. Cl. G01K 13/02; G10K 11/16; B33Y 80/00

(52) U.S. Cl. CPC G01K 13/028; G10K 11/161; B33Y 80/00

(57) ABSTRACT

An aircraft sensor assembly includes a mounting base for attachment to a surface, a probe head, and a strut. The strut includes a first end connected to the mounting base and a second end connected to the probe head. A leading edge extends from the first end to the second end in a direction of a longitudinal axis. A first side surface extends aft from the leading edge in a direction of an X axis that is transverse to the longitudinal axis. A second side surface extends aft from the leading edge in the direction of the X axis. The second side surface is opposite the first side surface. A first set of grooves is formed on at least the first side surface. The grooves modify airflow over the aircraft sensor assembly to reduce acoustic noise and vibration.

### BACKGROUND

The present disclose relates to aircraft sensors, and in particular, to total air temperature (TAT) sensors.

Aircraft sensors are important to proper operation of airplanes. Among these aircraft sensors are TAT sensors which measure the total temperature of the air outside of the plane which includes the static temperature of the air and another temperature component due to airspeed of the plane. Accurate information from these sensors is important to proper operation of the plane. These sensors often extend outward from the plane to get proper readings. Because TAT sensors extend outward from the plane, TAT sensors can experience unsteady flow even in steady inflow conditions, which leads to acoustic noise generation. The acoustic noise can be significant as unsteady flow oscillates from side to side on the TAT sensor. Therefore, solutions to reduce the noise generated by aircraft sensors that extend outward of the plane are desired.

### SUMMARY

In one example of the disclosure, a total air temperature sensor includes a strut and a probe head. The strut includes a first end opposite a second end, and a leading edge extending from the first end to the second end in a direction of a longitudinal axis. A first side surface extends aft from the leading edge in a direction of an X axis that is transverse to the longitudinal axis. A second side surface extends aft from the leading edge in the direction of the X axis, and the second side surface is opposite the first side surface. A first set of grooves is formed on at least the first side surface. The probe head is connected to the second end of the strut.

In another example of the disclosure, an aircraft sensor assembly includes a mounting base for attachment to a surface, a probe head, and a strut. The strut includes a first end connected to the mounting base and a second end connected to the probe head. A leading edge extends from the first end to the second end in a direction of a longitudinal axis. A first side surface extends aft from the leading edge in a direction of an X axis that is transverse to the longitudinal axis. A second side surface extends aft from the leading edge in the direction of the X axis, and the second side surface is opposite the first side surface. A set of grooves is formed on at least the first side surface.

### BRIEF DESCRIPTION OF THE DRAWINGS

FIG. 1A is a perspective view an aircraft sensor with surface grooves near a leading edge of the aircraft sensor.

FIG. 1B is an enlarged view of the surface grooves of the aircraft sensor of FIG. 1A.

FIG. 1C is a cross-sectional view of the leading edge of the aircraft sensor of FIG. 1A taken along line A-A.

FIG. 2 is a perspective view of another example of an aircraft sensor with surface grooves near a mid-chord region between a leading edge and a trailing end of the aircraft sensor.

FIG. 3 is a perspective view of another example of an aircraft sensor with surface grooves near a trailing end.

FIG. 4 is a front view of surface grooves that are serpentine and in phase with each other.

FIG. 5 is a front view of surface grooves that are serpentine and out of phase with each other.

FIG. 6A is a perspective view of an aircraft sensor with an alternating pattern of V-shaped grooves.

FIG. 6B is an enlarged view of the surface grooves of the aircraft sensor of FIG. 6A.

FIG. 7A is a front view of surface grooves on an aircraft sensor with a first set of triangular grooves and a second set of triangular grooves that is staggered from the first set of triangular grooves.

FIG. 7B is a cross-sectional view of the surface grooves of FIG. 7A taken along line B-B.

FIG. 8 is a cross-sectional view of another example of surface grooves with concave fluted grooves.

FIG. 9 is a cross-sectional view of another example of surface grooves with scalloped grooves.

FIG. 10 is a cross-sectional view of another example of surface grooves that includes grooves divided from each other by blades.

FIG. 11 is a cross-sectional view of another example of surface grooves that includes triangular grooves with a fillet radius.

FIG. 12 is a cross-sectional view of another example of surface grooves with convex fluted grooves.

FIG. 13 is a cross-sectional view of another example of surface grooves with surface ridges with a triangular cross-sectional profile formed through subtractive manufacturing.

FIG. 14 is a cross-sectional view of another example of surface grooves with surface ridges with a triangular cross-sectional profile formed through additive manufacturing.

FIG. 15 is a cross-sectional view of another example of surface grooves with surface ridges with a triangular cross-sectional profile formed through both additive manufacturing and subtractive manufacturing.

FIG. 16 is a perspective view of a pitot-static probe with surface grooves.

FIG. 17 is a perspective view of a total air temperature probe with a swept strut and surface grooves on the swept strut.

FIG. 18 is a perspective view of an angle of attack sensor with surface grooves.

While the above-identified drawing figures set forth one or more embodiments of the invention, other embodiments are also contemplated. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings. Like reference numerals identify similar structural elements.

### DETAILED DESCRIPTION

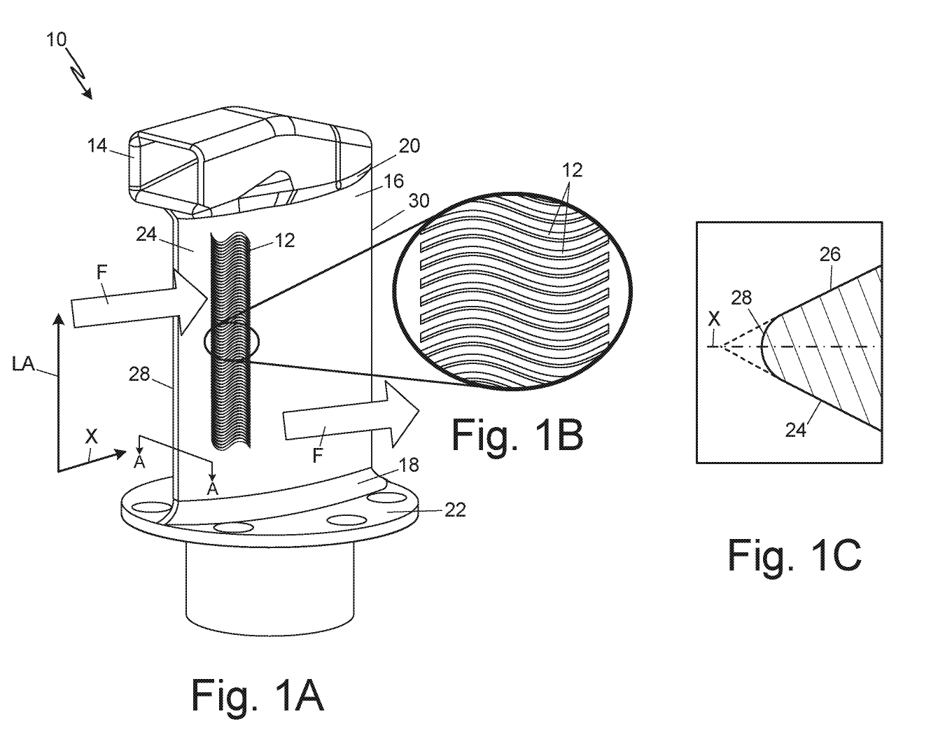

This disclosure relates to an aircraft sensor, such as a total air temperature sensor, that includes surface grooves that modifies airflow over the surface of the aircraft sensor. Modifying the airflow over the surface of the aircraft sensor reduces acoustic noise and vibration between the aircraft sensor and the airflow when compared to aircraft sensors without the surface grooves. The aircraft sensor with surface grooves will be discussed below with reference to FIGS. 1–18.

FIGS. 1A–1C will be discussed concurrently. FIG. 1A is a perspective view aircraft sensor 10 with surface grooves 12. FIG. 1B is an enlarged view of surface grooves 12 of aircraft sensor 10. In addition to surface grooves 12, aircraft sensor 10 also includes probe head 14, strut 16, strut first end 18, strut second end 20, and mounting base 22. Strut 16 includes first side surface 24, second side surface 26 (visible in FIG. 1C), leading edge 28, trailing side or end 30, longitudinal axis LA, and X axis. FIG. 1C is a cross-sectional view of leading edge 28 of aircraft sensor 10 of FIG. 1A taken along line A-A.

Aircraft sensor 10 represents a variety of aircraft sensors 10 including a total air temperature sensor, angle of attack sensor, pitot-static probe, or any other aircraft sensor 10 which extends beyond a body of an aircraft. In the example of FIGS. 1A–1C, aircraft sensor 10 is a total air temperature (TAT) sensor with probe head 14 connected to strut second end 20. Probe head 14 connects to strut 16 at strut second end 20, and mounting base 22 connects to strut 16 at strut first end 18. Probe head 14 of aircraft sensor 10 includes a scoop that draws ambient air from outside of an aircraft boundary flow layer and instrumentation that can detect external environmental conditions from the ambient air, such as total air temperature. The instrumentation inside of probe head 14 relays information regarding the external conditions to the aircraft.

Leading edge 28 of strut 16 extends from strut first end 18 to strut second end 20 in the direction of the longitudinal axis LA. Trailing side 30 of strut 16 extends from strut first end 18 to strut second end 20 in the direction of the longitudinal axis LA and is spaced from leading edge 28 in the direction of the X axis, which is transverse to the longitudinal axis LA. First side surface 24 of strut 16 extends from leading edge 28 to trailing edge 30 and extends between strut first end 18 and strut second end 20. Second side surface 26 of strut 16 extends from leading edge 28 to trailing side 30 and extends from strut first end 18 to strut second end 20. Trailing side 30 is positioned between first side surface 24 and second side surface 26. To reduce drag during flight, leading edge 28, trailing side 30, first side surface 24, and second side surface 26 form a streamlined profile that extends from leading edge 28 to trailing side 30.

In the embodiment shown in FIG. 1A, first side surface 24 and second side surface 26 can be equal in length. A length of first side surface 24 and a length of second side surface 26 is a distance along longitudinal axis LA. In an alternative embodiment, first side surface 24 can be longer than second side surface 26. In another alternative embodiment, second side surface 26 can be longer than first side surface 24. In the embodiment shown in FIG. 1A, a width of first side surface 24 is equal to the width of second side surface 26. The width of first side surface 24 and the width of second side surface 26 are a distance along X axis. In an alternative embodiment, the width of first side surface 24 can be greater than the width of second side surface 26. In another alternative embodiment, the width of first side surface 24 can be less than the width of second side surface 26.

Mounting base 22 includes a mounting flange for connecting aircraft sensor 10 to a surface of an aircraft. The surface can be an aircraft fuselage or any other suitable surface on the aircraft to attach aircraft sensor 10. Mounting base 22 can connect to the surface via bolts, screws, welds, brazing, or any other suitable attachment mechanism for adhering one surface to another in aerospace applications. When mounting base 22 is connected to the surface of the aircraft, strut 16 and probe head 14 extend beyond the body of the aircraft and become subject to airflow F. Airflow F over aircraft sensor 10 can lead to acoustic noise generation. Depending on the shape of aircraft sensor 10, the acoustic noise generation can be significant enough to be heard inside of the aircraft, leading to potential discomfort among the aircraft crew and passengers. Surface grooves 12 are formed on first side surface 24 and/or second side surface 26 to interact with the airflow F.

In the example of FIGS. 1A–1C, surface grooves 12 are formed on first side surface 24 of strut 16. In some examples, surface grooves 12 can be formed only on first side surface 24 of strut 16, surface grooves 12 can be formed only on second side surface 26 of strut 16, or surface grooves 12 can be formed on both first side surface 24 and second side surface 26. As shown best in FIGS. 1A and 1B surface grooves 12 can include multiple rows of grooves 12 stacked in the direction of the longitudinal axis LA between strut first end 18 and strut second end 20. In the example of FIGS. 1A and 1B, each surface groove 12 extends in length in the direction of the X axis between leading edge 28 and trailing side 30. Each surface groove 12 can include a wave-shaped profile as each surface groove 12 extends between leading edge 28 and trailing side 20. In the example of FIGS. 1A and 1B, surface grooves 12 are all in phase with one another such that all of surface grooves 12 increase and decrease in amplitude in unison in the direction of the longitudinal axis LA as surface grooves 12 extend in the direction of the X axis between leading edge 28 and trailing side 20. In other examples, each surface groove 12 can be out of phase with an adjacent surface groove 12.

Surface grooves 12 can be formed on first side surface 24 and/or second side surface 26 through an etching process that removes material from first side surface 24 and/or second side surface 26. The etching process can include machine etching, chemical etching, and/or laser etching. In other examples, surface grooves 12 can be formed on first side surface 24 and/or second side surface 26 through an additive manufacturing process. For example, surface grooves 12 can be formed by additively manufacturing surface ridges on first side surface 24 and/or second side surface 26, with the spaces between the surface ridges forming surface grooves 12. The additive manufacturing process can include laser powder bed fusion. In other examples, surface grooves 12 can be formed during an initial casting process of strut 16. A corrosion resistant topcoat of another material can be applied over first side surface 24 and second side surface 26, including over surface grooves 12. The corrosion resistant topcoat can be applied via electroplating, chemical vapor deposition, or any other method known to those of skill in the art to apply a corrosion resistant topcoat to another surface.

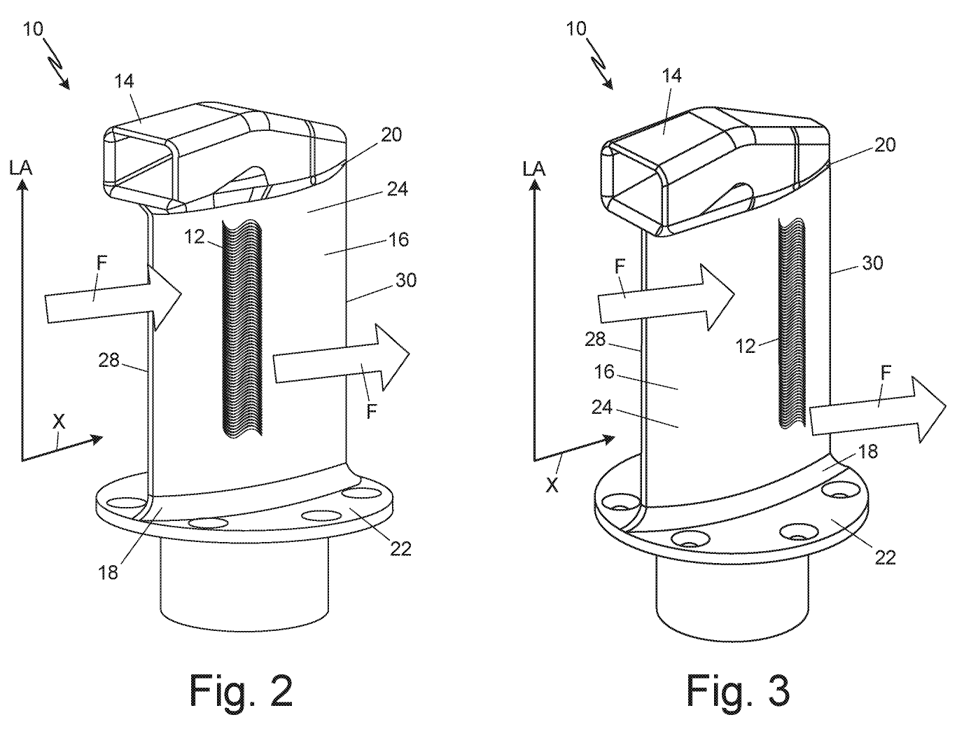

When airflow F passes over strut 16, the airflow F first encounters leading edge 28 and then flows over first side surface 24 and second side surface 26. As the airflow F passes over surface grooves 12, surface grooves 12 weaken a laminar boundary flow of the airflow F on first side surface 24 and/or second side surface 26. This weakening of the laminar boundary flow by surface grooves 12 can deliberately trip the laminar boundary flow into a turbulent flow. Tripping the laminar boundary flow of the airflow F on first side surface 24 and/or second side surface 26 into a turbulent flow can reduce or eliminate the formation of flow instability in the airflow F adjacent to strut 16 and aft of strut 16. Reducing or eliminating flow instability in the airflow F around strut 16 reduces flow-induced vibration of aircraft sensor 10 and the acoustic noise that can accompany such flow instabilities and vibration. To further improve noise reduction of aircraft sensor 10, leading edge 28 of strut 16 can be rounded. As shown in FIG. 1C, leading edge 28 of strut 16 can be rounded between first side surface 24 and second side surface 26, such that leading edge 28 of strut 16 has a curved surface between first side surface 24 and second side surface 26 in place of a sharp edge (represented by dashed lines in FIG. 1C). In some examples, the curved surface of leading edge 28 can have a radius of approximately 1.0 mm to 2.0 mm. For best results, surface grooves 12 can be positioned on first side surface 24 and/or second side surface 26 within 5% to 30% of chord from leading edge 28. Chord is defined as a straight line distance between leading edge 28 and trailing side 30 along the X axis. While the example of FIGS. 1A–1C shows surface grooves 12 being positioned on first side surface 24 and/or second side surface 26 near leading edge 28, other examples can have surface grooves 12 positioned further away from leading edge 28 in the direction of the X axis, as discussed below with reference to FIGS. 2 and 3.

FIG. 2 is a perspective view of another example of aircraft sensor 10 with surface grooves 12 positioned on first side surface 24 of strut 16 midway between leading edge 28 and trailing side 30. While not visible in FIG. 2, second side surface 26 of strut 16 can also include surface grooves 12 positioned midway between leading edge 28 and trailing side 30. FIG. 3 is a perspective view of another example of aircraft sensor 10 with surface grooves 12 positioned on first side surface 24 near trailing side 30. While not visible in FIG. 3, second side surface 26 of strut 16 can also include surface grooves 12 positioned near trailing side 30.

Surface grooves 12 can be formed anywhere on the surface of strut 16. In the examples of FIGS. 1A–3, surface grooves 12 are arranged in a column that extends substantially in the direction of longitudinal axis LA. In alternative examples not shown in the figures, surface grooves 12 can extend at an angle with respect to longitudinal axis LA. The angle between a direction that surface grooves 12 substantially extend and the longitudinal axis LA can be at least 5 degrees, at least 10 degrees, or at least 25 degrees. In other examples not shown in the figures, there can be multiple columns of surface grooves 12. Each column of surface grooves 12 can have a different orientation with respect to longitudinal axis LA, a different ridge pattern, and/or a different cross-sectional pattern.

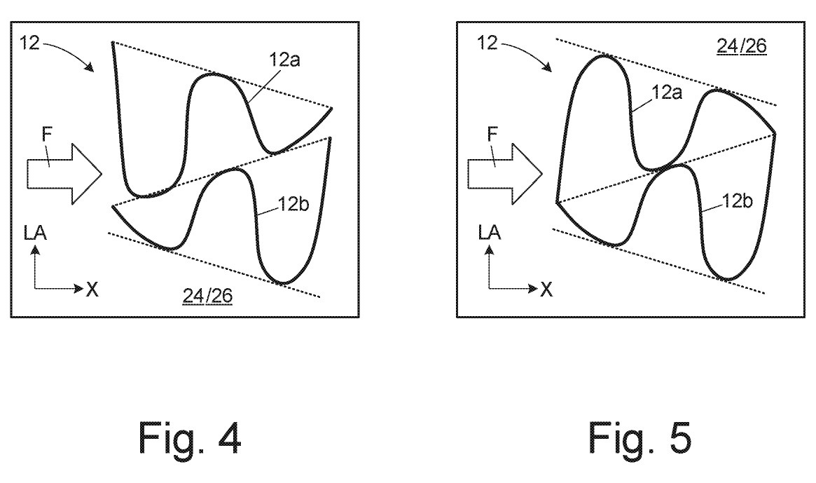

FIG. 4 is a front view of surface grooves 12 that are serpentine. In the example of FIG. 4, surface grooves 12 include first surface groove 12a and second surface groove 12b. First surface groove 12a oscillates in a generally wave-like pattern with peaks and valleys that decrease in amplitude in the direction of longitudinal axis LA as first surface groove 12a extends in the direction of the X axis toward trailing side 30 (shown in FIGS. 1A–3). Second surface groove 12b is positioned adjacent to first surface groove 12a in the direction of longitudinal axis LA. Second surface groove 12b also oscillates in a generally wave-like pattern with peaks and valleys. However, second surface groove 12b increase in amplitude in the direction of longitudinal axis LA as second surface groove 12b extends in the direction of the X axis toward trailing side 30. In the example of FIG. 4, second surface groove 12b is in phase with first surface groove 12a in the direction of the X axis such that the valleys of second surface groove 12b are aligned in the direction of the X axis with the valleys of first surface groove 12a, and the peaks of second surface groove 12b are aligned in the direction of the X axis with the peaks of first surface groove 12a.

FIG. 5 is another example of surface grooves 12 with first surface groove 12a and second surface groove 12b that are both serpentine. However, in the example of FIG. 5, first surface groove 12a and second surface groove 12b are out of phase with each other. As shown in FIG. 5, first surface groove 12a oscillates in a generally wave-like pattern with peaks and valleys that decrease in amplitude in the direction of longitudinal axis LA as first surface groove 12a extends in the direction of the X axis toward trailing side 30 (shown in FIGS. 1A–3). Second surface groove 12b is positioned adjacent to first surface groove 12a in the direction of longitudinal axis LA. Second surface groove 12b also oscillates in a generally wave-like pattern with peaks and valleys. However, second surface groove 12b increase in amplitude in the direction of longitudinal axis LA as second surface groove 12b extends in the direction of the X axis toward trailing side 30. In the example of FIG. 5, second surface groove 12b is out of phase with first surface groove 12a in the direction of the X axis such that the valleys of second surface groove 12b are aligned in the direction of the X axis with the peaks of first surface groove 12a, and the peaks of second surface groove 12b are aligned in the direction of the X axis with the valleys of first surface groove 12a.

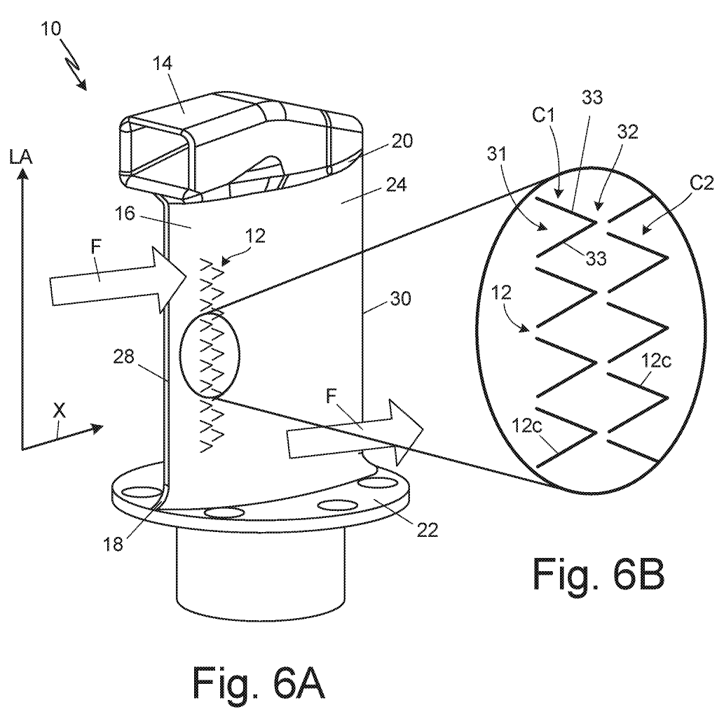

FIG. 6A is a perspective view of aircraft sensor 10 with surface grooves 12 that include an alternating pattern of V-shaped grooves 12c. FIG. 6B is an enlarged view of V-shaped grooves 12c of aircraft sensor 10 of FIG. 6A. In the example of FIGS. 6A and 6B, V-shaped grooves 12c are arranged on first side surface 24 in first column C1 and second column C2. Columns of V-shaped grooves 12c can also be present on second side surface 26, which is not visible in FIGS. 6A and 6B. Both first column C1 and second column C2 of V-shaped grooves 12c extend in the direction of longitudinal axis LA between strut first end 18 and second strut end 20. Each V-shaped groove 12c in first column C1 and second column C2 includes open end 31, closed end 32, and a pair of legs 33. Legs 33 of each V-shaped groove 12c extend from open end 31 to closed end 32. At open end 31, the pair of legs 33 of each V-shaped groove 12c are spaced apart from one another. As the pair of legs 33 extend on first side surface 24 (or second side surface 26) from open end 31 toward closed end 32 in the direction of the X axis, the pair of legs 33 converge toward one another. At closed end 32, the pair of legs 33 meet to form a “V” shape. Open end 31 of each V-shaped groove 12c is positioned upstream from closed end 32 relative to the airflow F. V-shaped grooves 12c in second column C2 are offset from V-shaped grooves 12c in first column C1 such that open end 31 of each V-shaped groove 12c in second column C2 is positioned between closed ends 32 of two V-shaped grooves 12c in first column C1 relative to the direction of the longitudinal axis LA.

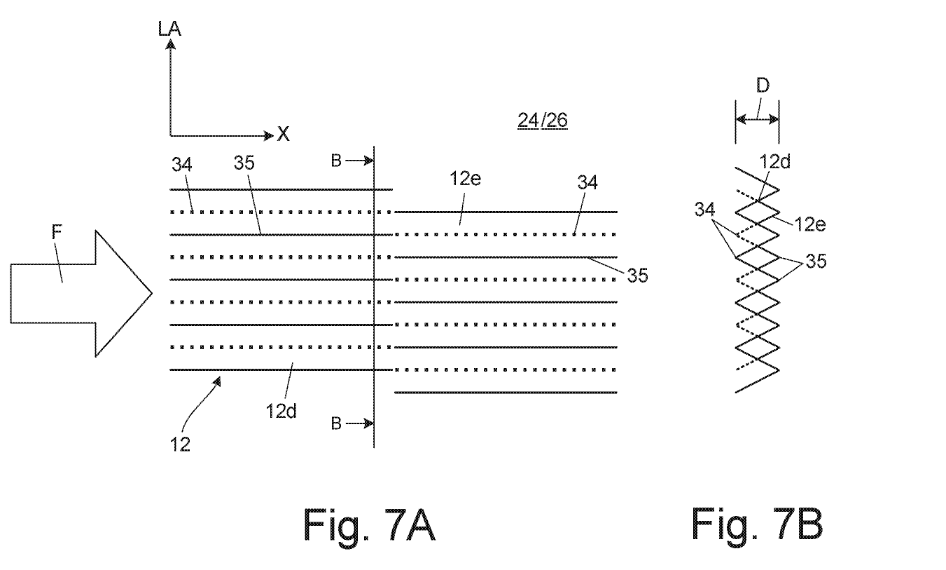

FIG. 7A is a front view of surface grooves 12 on first side surface 24 or second side surface 26 of aircraft sensor 10 with a first set of grooves 12d and a second set of grooves 12e. FIG. 7B is a cross-sectional view of surface grooves 12 of FIG. 7A taken along line B-B. Surface grooves 12 in both the first set of grooves 12d and the second set of grooves 12e have a triangular cross-section that extends into first side surface 24 or second side surface 26 of strut 16 in a depth dimension D. The depth of surface grooves 12 in both the first set of grooves 12d and the second set of grooves 12e in the depth dimension D can be less than 0.3 mm. Each surface groove 12 is separated from adjacent surface grooves 12 by ridges 35. A bottom of each surface groove 12 in the depth dimension D is formed by trough 34. Each surface groove 12 in the first set of grooves 12d extends primarily in the direction of the X axis. Surface grooves 12 in the first set of grooves 12d are positioned adjacent to one another in the longitudinal axis LA such that the first set of grooves 12d form an alternating pattern of ridges 35 and troughs 34.

The second set of grooves 12e is immediately aft of the first set of grooves 12d. Each surface groove 12 in the second set of grooves 12e extends primarily in the direction of the X axis. Surface grooves 12 in the second set of grooves 12e can be parallel to surface grooves 12 in the first set of grooves 12d. Surface grooves 12 in the second set of grooves 12e are positioned adjacent to one another in the longitudinal axis LA such that the second set of surface grooves 12e form an alternating pattern of ridges 35 and troughs 34. As shown in FIGS. 7A and 7B, the second set of grooves 12e is staggered from the first set of grooves 12d in the longitudinal axis LA such that ridges 35 of the first set of grooves 12d are aligned with troughs 34 of the second set of grooves 12e in the direction of the X axis. While the example of FIGS. 7A and 7B show surface grooves 12 with a triangular cross-section in the depth dimension D, surface grooves 12 can include a different cross-sectional profiles and patterns, as shown below in FIGS. 8–12.

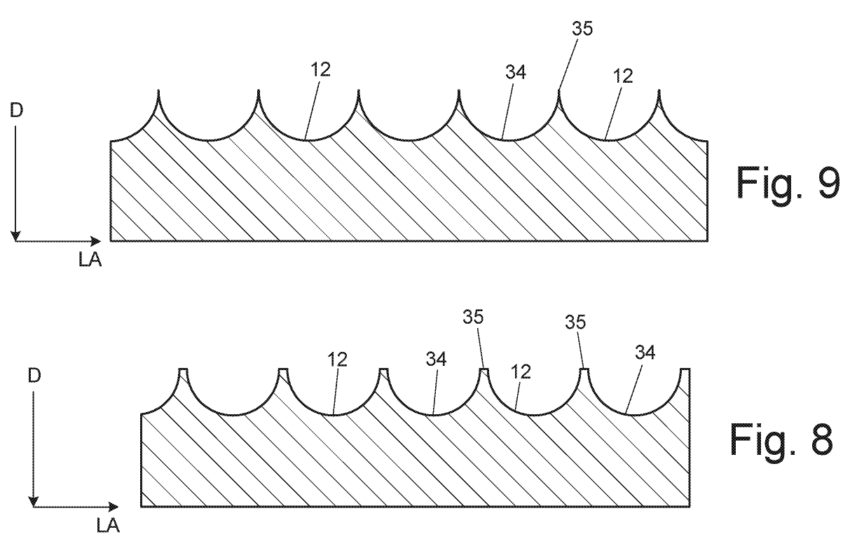

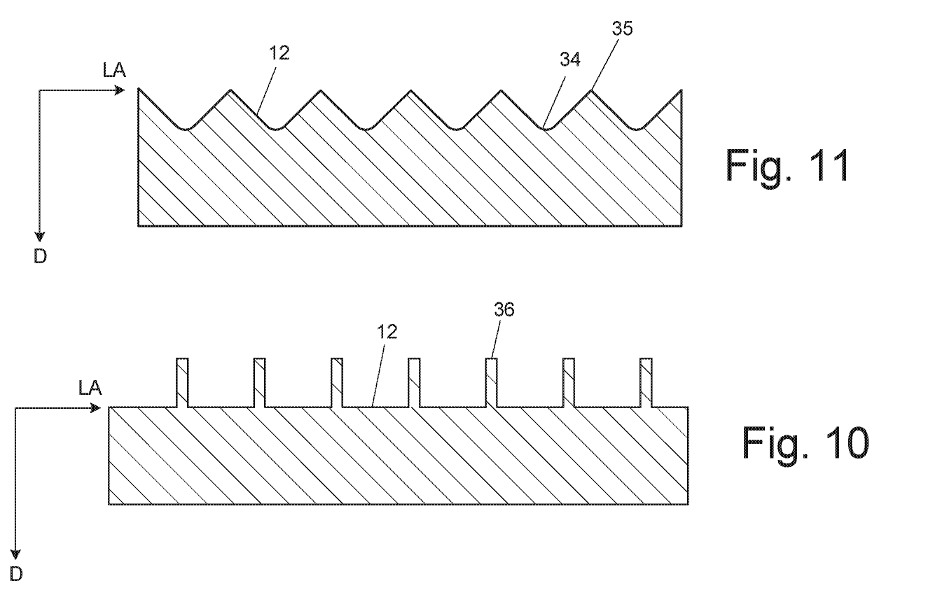

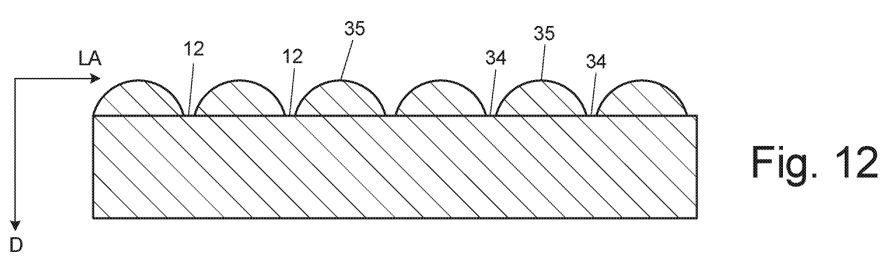

FIGS. 8–12 show various possible cross-sectional profiles for surface grooves 12 and will be discussed together. Surface grooves 12 formed on strut 16 can have many different cross-sectional profiles. These cross-sectional profiles change the way that air flows through surface grooves 12. FIG. 8 is a cross-sectional view of an example of surface grooves 12 where each surface groove 12 includes trough 34 that is concave. Ridges 35 between each concave trough 34 has a flat top surface. Together, ridges 35 and concave troughs 34 form a concave fluted groove profile in surface grooves 12. FIG. 9 is a cross-sectional view of an example of surface grooves 12 with scalloped profile. Each surface groove 12 in the example of FIG. 9 includes a concave trough 34. Ridges 35 between each concave trough 34 includes a sharp top edge. Together, ridges 35 and concave troughs 34 form the scalloped profile in surface grooves 12 of the example of FIG. 9. FIG. 10 is a cross-sectional view of an example with blades 36 separating surface grooves 12 from each other. In the example of FIG. 10, surface grooves 12 include a rectangular cross-sectional profile with blades 36 forming dividing walls between surface grooves 12. FIG. 11 is a cross-sectional view of another example of surface grooves 12 with a triangular profile. In the example of FIG. 11, surface grooves 12 include a fillet radius at a bottom of trough 34 that rounds out the triangular profile or surface grooves 12 and forms a smooth transition between troughs 34 and ridges 35. FIG. 12 is a cross-sectional view of an example of surface grooves 12 with convex ridges 35 and fluted grooves 34.

The profile examples of surface grooves 12 shown in FIGS. 8–12 can be used on first side surface 24 and/or second side surface 26 of strut 16 (shown in FIGS. 1A–3) of aircraft sensor 10. When airflow F passes over strut 16, the example profiles of surface grooves 12 shown in FIGS. 8–12 weaken a laminar boundary flow of the airflow F on first side surface 24 and/or second side surface 26. This weakening of the laminar boundary flow by surface grooves 12 can deliberately trip the laminar boundary flow into a turbulent flow. As previously noted above, tripping the laminar boundary flow of the airflow F on first side surface 24 and/or second side surface 26 into a turbulent flow can reduce or eliminate the formation of Kelvin-Helmholtz instability in the airflow F adjacent to strut 16 and aft of strut 16. Reducing or eliminating Kelvin-Helmholtz instability in the airflow F around strut 16 reduces flow-induced vibration of aircraft sensor 10 and the acoustic noise that can accompany such flow instabilities and vibration.

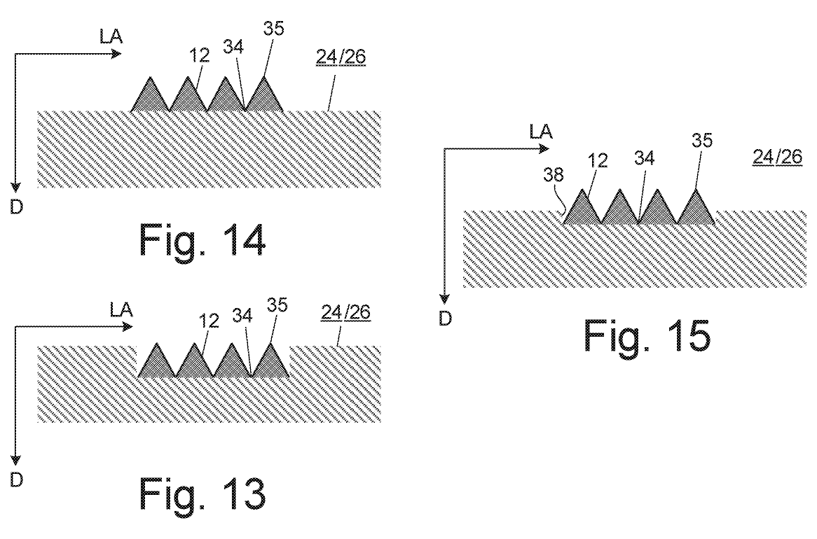

As shown in FIGS. 13–15, surface grooves 12 can be formed on first side surface 24, and/or second side surface 26 of strut 16 by subtractive manufacturing and/or additive manufacturing. FIGS. 13–15 will be discussed concurrently. FIG. 13 is a cross-sectional view of another example of surface grooves 12 with ridges 35 and troughs 34 that include a triangular cross-sectional profile. In the example of FIG. 13 surface grooves 12 are formed by subtractive manufacturing (e.g., machining or milling) troughs 34 into first side surface 24 and/or second side surface 26 of strut 16. Since surface grooves 12 are formed via subtractive manufacturing in the example of FIG. 13, surface grooves 12 are recessed within first side surface 24 and/or second side surface 26 of strut 16.

FIG. 14 is a cross-sectional view of another example of surface grooves 12 with ridges 35 and troughs 34 that include a triangular cross-sectional profile. In the example of FIG. 14, surface grooves 12 are formed by additively manufacturing (e.g., laser powder fusion) ridges 35 onto first side surface 24 and/or second side surface 26 of strut 16. Since surface grooves 12 are formed via additive manufacturing in the example of FIG. 14, surface grooves 12 are elevated above first side surface 24 and/or second side surface 26 of strut 16.

FIG. 15 is a cross-sectional view of another example of surface grooves 12 with ridges 35 and troughs 34 that include a triangular cross-sectional profile. In the example of FIG. 15, surface grooves 12 are formed by a combination of subtractive manufacturing and additive manufacturing. In the example of FIG. 15, recess 38 is first formed into first side surface 24 and/or second side surface 26 of strut 16 via subtractive manufacturing. Once recess 38 has been formed on strut 16, ridges 35 can be additively manufactured in recess 38 to complete surface grooves 12. Since surface grooves 12 are formed in recess 38, ridges 35 and surface grooves 12 are partially recessed into first side surface 24 and/or second side surface 26 of strut 16.

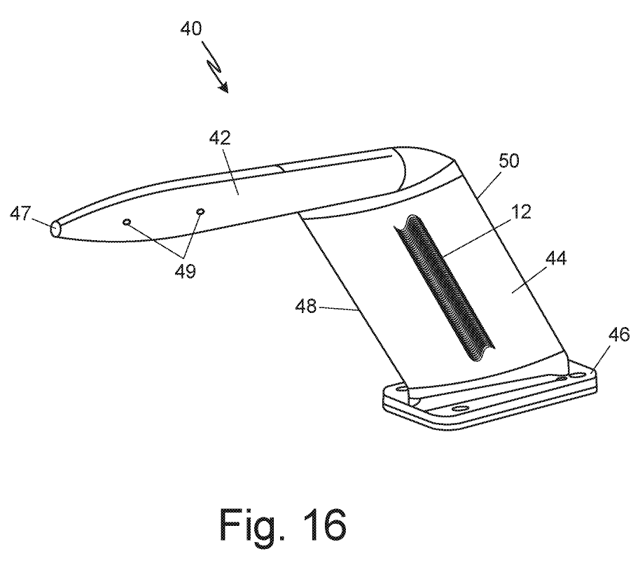

While surface grooves 12 have been described above, with respect to FIGS. 1A–3, being formed on a surface of strut 16 of a total air temperature sensor, it will be understood by those skilled in the art that surface grooves 12 can also be used on other external aircraft sensors and probes. Therefore, it is intended that this disclosure not be limited to a vertical strut of a total air temperature sensor as disclosed with respect to FIGS. 1A–3, but that the disclosure will include all embodiments falling within the scope of the appended claims. For example, FIGS. 16–18 show various alternative probes with surface grooves 12.

FIG. 16 is a perspective view of pitot-static probe 40. Pitot-static probe 40 includes probe head 42, strut 44, and mounting flange 46. Probe head 42 includes tip 47 and static ports 49. Strut 44 includes leading edge 48, trailing edge 50, and surface grooves 12.

As best shown in FIG. 16, pitot-static probe 40 can be a pitot probe or any other suitable air data probe. Probe head 42 forms a forward-most portion of pitot-static probe 40. Probe head 40 has one or more ports that communicate external air and pressure to sensors located within probe head 40. Probe head 40 is connected to a first end of strut 44. Strut 44 can be blade shaped. A second end of strut 44 is connected to mounting flange 46. Mounting flange 46 makes up a mounting interface for connecting pitot-static probe 40 to an aircraft. Pitot-static probe 40 can be mounted to a fuselage of the aircraft via mounting flange 46 and fasteners, such as screws or bolts.

Strut 44 has leading edge 48 at a forward, or upstream, side of strut 44. Trailing edge 50 is at an aft, or downstream, side of strut 44. Leading edge 48 is opposite trailing edge 50. Strut 44 holds probe head 42 away from the fuselage of the aircraft to expose probe head 42 to external airflow. Probe head 42 takes in air from surrounding external airflow and communicates air pressures pneumatically through internal components and passages in probe head 42 and strut 44. Pressure measurements are communicated to a flight computer and can be used to generate air data parameters related to the aircraft flight condition. Similar to the examples of FIGS. 1A–3, surface grooves 12 can be formed on strut 44. Surface grooves 12 provide the same benefits to pitot-static probe 40 as described above with reference to FIGS. 1A–3.

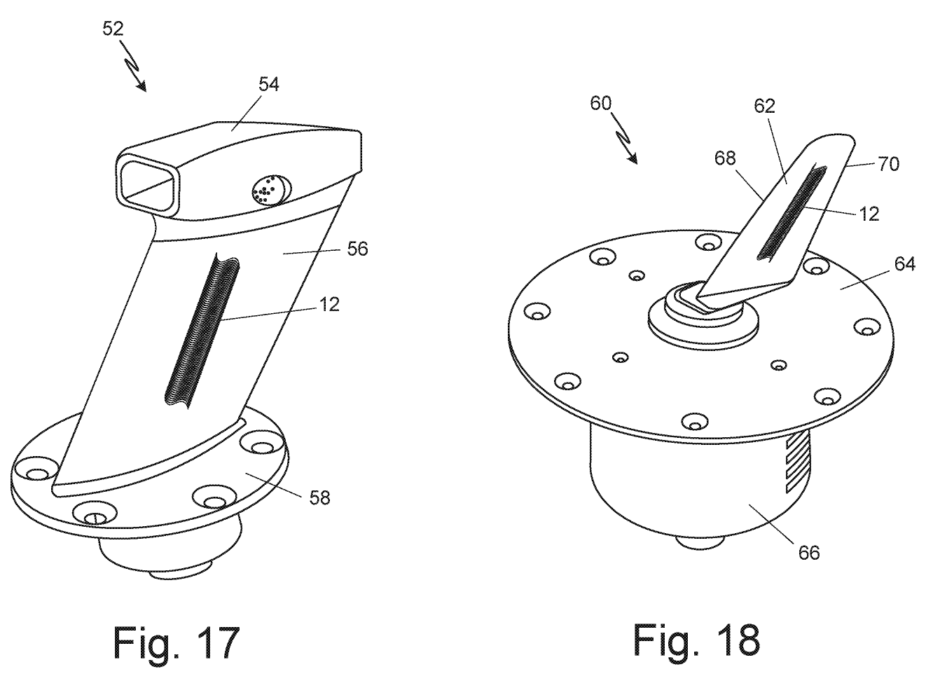

FIG. 17 is a perspective view of total air temperature probe 52. Total air temperature probe 52 includes head 54, strut 56, and mounting flange 58. Total air temperature probe 52 is similar to the total air temperature probe of aircraft sensor 10 in the example of FIGS. 1A–3, except strut 56 is aftward swept. Surface grooves 12 are formed on strut 56 and impart the same benefits to total air temperature probe 52 as described above with reference to FIGS. 1A–3.

FIG. 18 is a perspective view of angle of attack sensor 60. Angle of attack sensor 60 includes vane 62, faceplate 64, and housing 66. Vane 62 includes leading edge 68 and trailing edge 70. Surface grooves 12 are formed on an outer surface of vane 62. Vane 62 is adjacent faceplate 64. Faceplate 64 is positioned on and connected to housing 66. Internal components of angle of attack sensor 60 are located within housing 66. Leading edge 68 is a forward or upstream edge of vane 62 and trailing edge 70 is aft and downstream of leading edge 68.

Angle of attack sensor 60 can be mounted to a fuselage of the aircraft via faceplate 64 and fasteners, such as screws or bolts. Vane 62 extends outside an exterior of the aircraft and is exposed to external airflow, and housing 66 extends within an interior of the aircraft. External airflow causes vane 62 to rotate with respect to faceplate 64 via a series of bearings within angle of attack sensor 60. Vane 62 rotates based on the angle at which the aircraft is flying relative to the external oncoming airflow. Vane 62 causes rotation of a vane base and vane shaft within housing 66. The vane shaft is coupled to a rotational sensor that measures the local angle of attack or angle of the airflow relative to the fixed aircraft structure. Surface grooves 12 provide the same benefits to angle of attack sensor 60 as described above with reference to FIGS. 1A–3.

### Discussion of Possible Embodiments

The following are non-exclusive descriptions of possible embodiments of the present invention.

In one example, a total air temperature sensor includes a strut and a probe head. The strut includes a first end opposite a second end, and a leading edge extending from the first end to the second end in a direction of a longitudinal axis. A first side surface extends aft from the leading edge in a direction of an X axis that is transverse to the longitudinal axis. A second side surface extends aft from the leading edge in the direction of the X axis, and the second side surface is opposite the first side surface. A first set of grooves is formed on at least the first side surface. The probe head is connected to the second end of the strut.

The total air temperature sensor of the preceding paragraph can optionally include, additionally and/or alternatively, any one or more of the following features, configurations and/or additional components in the paragraphs below.

In an embodiment of the foregoing total air temperature sensor, each groove in the first set of grooves has a depth less than 0.3 mm.

In an embodiment of the foregoing total air temperature sensor, the total air temperature sensor further comprises: ridges formed on at least the first side surface; and troughs formed on at least the first side surface, wherein the troughs space each of the ridges apart from one another to form the first set of grooves.

In an embodiment of the foregoing total air temperature sensor, the ridges are additively manufactured on the first side surface such that the ridges extend outward from the first side surface.

In an embodiment of the foregoing total air temperature sensor, the troughs are formed by an etching process such that the troughs extend into the first side surface and are recessed within the first side surface.

In an embodiment of the foregoing total air temperature sensor, the total air temperature sensor further comprises: a recess formed in the first side surface of the strut, and wherein the ridges are additively manufactured in the recess such that the ridges are partially recessed within the first side surface of the strut.

In an embodiment of the foregoing total air temperature sensor, the first set of grooves comprises: a first groove with a wave-like pattern that extends in the direction of the X axis, wherein the wave-like pattern decreases in amplitude as the first groove extends away from the leading edge in the direction of the X axis; and a second groove with a wave-like pattern that extends in the direction of the X axis, wherein the wave-like pattern of the second groove increases in amplitude as the second groove extends away from the leading edge in the direction of the X axis, and wherein the second groove is adjacent to the first groove in the direction of the longitudinal axis.

In an embodiment of the foregoing total air temperature sensor, the wave-like pattern of the first groove is in phase with the wave-like pattern of the second groove.

In an embodiment of the foregoing total air temperature sensor, the wave-like pattern of the first groove is out of phase with the wave-like pattern of the second groove.

In an embodiment of the foregoing total air temperature sensor, the first set of grooves: a first column of V-shaped grooves extending between the first end and the second end of the strut in the direction of the longitudinal axis; and a second column of V-shaped grooves extending between the first end and the second end of the strut in the direction of the longitudinal axis, wherein the second column of V-shaped grooves is aft of the first column of V-shaped grooves in the direction of the X axis, and wherein the second column of V-shaped grooves is offset from the first column of V-shaped grooves in the direction of the longitudinal axis.

In an embodiment of the foregoing total air temperature sensor, at least one groove of the first set of grooves comprises a concave cross-sectional profile.

In an embodiment of the foregoing total air temperature sensor, at least one groove of the first set of grooves comprises a convex cross-sectional profile.

In an embodiment of the foregoing total air temperature sensor, at least one groove of the first set of grooves comprises a triangular cross-sectional profile with a rounded fillet in a bottom of the at least one groove.

In an embodiment of the foregoing total air temperature sensor, each ridge comprises a convex cross-sectional profile and each trough comprises a fluted cross-sectional profile.

In an embodiment of the foregoing total air temperature sensor, the total air temperature sensor further comprises: second ridges formed on the first side surface aft of the troughs in the direction of the X axis and aligned with the troughs in the direction of the longitudinal axis; and second troughs formed on the first side surface, wherein the second troughs space each of the second ridges apart from one another to form a second set of grooves, and wherein the second troughs are aft of the ridges in the direction of the X axis and aligned with the ridges in the direction of the longitudinal axis.

In an embodiment of the foregoing total air temperature sensor, the total air temperature sensor further comprises a second set of grooves formed on the second side surface.

In an embodiment of the foregoing total air temperature sensor, the leading edge is rounded, wherein the first set of grooves are adjacent to the leading edge on the first side surface, and the second set of grooves are adjacent to the leading edge on the second side surface.

In another example, an aircraft sensor assembly includes a mounting base for attachment to a surface, a probe head, and a strut. The strut includes a first end connected to the mounting base and a second end connected to the probe head. A leading edge extends from the first end to the second end in a direction of a longitudinal axis. A first side surface extends aft from the leading edge in a direction of an X axis that is transverse to the longitudinal axis. A second side surface extends aft from the leading edge in the direction of the X axis, and the second side surface is opposite the first side surface. A set of grooves is formed on at least the first side surface.

The aircraft sensor assembly of the preceding paragraph can optionally include, additionally and/or alternatively, any one or more of the following features, configurations and/or additional components in the paragraphs below.

In an embodiment of the foregoing aircraft sensor assembly, the aircraft sensor assembly further comprises a second set of grooves formed on the second side surface.

In an embodiment of the foregoing aircraft sensor assembly, each groove of the first set of grooves comprises a depth that extends less than 0.3mm into the first side surface, and wherein the first set of grooves is within 5% to 30% of chord from leading edge, wherein chord is defined as a straight line distance between the leading edge and a trailing end of the strut.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A total air temperature sensor comprising:
a strut comprising:
a first end opposite a second end;
a leading edge extending from the first end to the second end in a direction of a longitudinal axis;
a first side surface extending aft from the leading edge in a direction of an X axis that is transverse to the longitudinal axis;
a second side surface extending aft from the leading edge in the direction of the X axis, wherein the second side surface is opposite the first side surface; and
a first set of grooves formed on at least the first side surface; and
a probe head connected to the second end of the strut.

2. The total air temperature sensor of claim 1, wherein each groove in the first set of grooves has a depth less than 0.3 mm.

3. The total air temperature sensor of claim 2, further comprising:
ridges formed on at least the first side surface; and
troughs formed on at least the first side surface, wherein the troughs space each of the ridges apart from one another to form the first set of grooves.

4. The total air temperature sensor of claim 3, wherein the ridges are additively manufactured on the first side surface such that the ridges extend outward from the first side surface.

5. The total air temperature sensor of claim 3, wherein the troughs are formed by an etching process such that the troughs extend into the first side surface and are recessed within the first side surface.

6. The total air temperature sensor of claim 3, further comprising:
a recess formed in the first side surface of the strut, and
wherein the ridges are additively manufactured in the recess such that the ridges are partially recessed within the first side surface of the strut.

7. The total air temperature sensor of claim 3, wherein the first set of grooves comprises:
a first groove with a wave-like pattern that extends in the direction of the X axis, wherein the wave-like pattern decreases in amplitude as the first groove extends away from the leading edge in the direction of the X axis; and
a second groove with a wave-like pattern that extends in the direction of the X axis, wherein the wave-like pattern of the second groove increases in amplitude as the second groove extends away from the leading edge in the direction of the X axis, and wherein the second groove is adjacent to the first groove in the direction of the longitudinal axis.

8. The total air temperature sensor of claim 7, wherein the wave-like pattern of the first groove is in phase with the wave-like pattern of the second groove.

9. The total air temperature sensor of claim 7, wherein the wave-like pattern of the first groove is out of phase with the wave-like pattern of the second groove.

10. The total air temperature sensor of claim 3, wherein the first set of grooves:
a first column of V-shaped grooves extending between the first end and the second end of the strut in the direction of the longitudinal axis; and
a second column of V-shaped grooves extending between the first end and the second end of the strut in the direction of the longitudinal axis, wherein the second column of V-shaped grooves is aft of the first column of V-shaped grooves in the direction of the X axis, and wherein the second column of V-shaped grooves is offset from the first column of V-shaped grooves in the direction of the longitudinal axis.

11. The total air temperature sensor of claim 3, wherein at least one groove of the first set of grooves comprises a concave cross-sectional profile.

12. The total air temperature sensor of claim 3, wherein at least one groove of the first set of grooves comprises a convex cross-sectional profile.

13. The total air temperature sensor of claim 3, wherein at least one groove of the first set of grooves comprises a triangular cross-sectional profile with a rounded fillet in a bottom of the at least one groove.

14. The total air temperature sensor of claim 3, wherein each ridge comprises a convex cross-sectional profile and each trough comprises a fluted cross-sectional profile.

15. The total air temperature sensor of claim 3, further comprising:
second ridges formed on the first side surface aft of the troughs in the direction of the X axis and aligned with the troughs in the direction of the longitudinal axis; and
second troughs formed on the first side surface, wherein the second troughs space each of the second ridges apart from one another to form a second set of grooves, and wherein the second troughs are aft of the ridges in the direction of the X axis and aligned with the ridges in the direction of the longitudinal axis.

16. The total air temperature sensor of claim 2, further comprising:
a second set of grooves formed on the second side surface.

17. The total air temperature sensor of claim 16, wherein the leading edge is rounded, wherein the first set of grooves are adjacent to the leading edge on the first side surface, and the second set of grooves are adjacent to the leading edge on the second side surface.

18. An aircraft sensor assembly comprising:
a mounting base for attachment to a surface;
a probe head;
a strut comprising:
a first end connected to the mounting base;
a second end connected to the probe head; and
a leading edge extending from the first end to the second end in a direction of a longitudinal axis;
a first side surface extending aft from the leading edge in a direction of an X axis that is transverse to the longitudinal axis;
a second side surface extending aft from the leading edge in the direction of the X axis, wherein the second side surface is opposite the first side surface; and
a set of grooves formed on at least the first side surface.

19. The aircraft sensor assembly of claim 18, further comprising:
a second set of grooves formed on the second side surface.

20. The aircraft sensor assembly of claim 19, wherein each groove of the first set of grooves comprises a depth that extends less than 0.3mm into the first side surface, and wherein the first set of grooves is within 5% to 30% of chord from leading edge, wherein chord is defined as a straight line distance between the leading edge and a trailing end of the strut.
